(19) United States
(12) Patent Application Publication
(10) Pub. No.: US 2026/0162185 A1
(43) Pub. Date: Jun. 11, 2026

(54) SYSTEMS AND METHODS FOR PREDICTING RISK LEVELS TO BUILDING EXTERIORS DUE TO WEATHER EVENTS

(71) Applicant: State Farm Mutual Automobile Insurance Company, Blooming, IL (US)

(72) Inventors: Joshua M. Mast, Bloomington, IL (US); Douglas L. Dewey, Bloomington, IL (US); Todd Binion, Bloomington, IL (US); Jeffrey Feid, Normal, IL (US)

(21) Appl. No.: 19/537,974

(22) Filed: Feb. 12, 2026

Related U.S. Application Data
(63) Continuation of application No. 17/335,266, filed on Jun. 1, 2021.

(51) Int. Cl. G06Q 40/08

(52) U.S. Cl. CPC G06Q 40/08

(57) ABSTRACT

Systems and methods for predicting risk levels of damage to building exterior elements due to weather events are disclosed. Such exterior elements may include siding, gutters, windows, doors, etc. Weather data may be obtained and used to determine that a weather event has impacted, or is predicted to impact, a geographic area. Building data and exterior element data for a building may be received and used to determine that the building is located within the geographic area of the weather event. An event-based risk score for the building indicating a probability of damage to the exterior elements of the building due to the weather event is calculated based upon the building data, the exterior element data, the weather data, and, if available, a baseline risk score for the building. Remedial actions to avoid or limit such damage may be determined based upon the event-based damage prediction.

### CROSS-REFERENCE TO RELATED APPLICATIONS

This application is a continuation of U.S. patent application Ser. No. 17/335,266, entitled “Systems and Methods for Predicting Risk Levels to Building Exteriors Due to Weather Events,” filed on Jun. 1, 2021, the entire content of which is hereby incorporated herein by reference.

### TECHNICAL FIELD

The present disclosure generally relates to systems and methods for predicting risk levels for damage to building exteriors, and more particularly to systems and methods for determining a probability of damage predicted to occur to exterior elements of a building due to a weather event.

### BACKGROUND

A building exterior may be damaged by weather events and/or by wear-and-tear due to a climate where the building is located. However, it is generally difficult to predict the likelihood that a particular building will be damaged due to a weather event and/or the likelihood that a building will be damaged within a future time interval (e.g., within the next year). For example, a storm predicted to impact a geographic region may impact different buildings of the geographic region in different ways, depending on factors unique to each building, such as the precise location of the building, the orientation of the building, and the materials used in the building. Accordingly, due to building-specific factors, even if a storm is predicted to impact a geographic location including a building, determining whether the building will actually experience damage due to the storm can be challenging. Likewise, determining how probable a building is to experience damage over a given time-interval can also be complicated by the wide variation in damage susceptibility between different buildings.

### SUMMARY

The present embodiments relate to, inter alia, predicting risk levels to building exteriors due to weather events. Additional, fewer, or alternative features described herein below may be included in some aspects.

In one aspect, a computer-implemented method for predicting risk levels to building exteriors due to weather events may be provided. The method may be implemented by one or more processors and may include: receiving weather data indicating attributes of a weather event; determining that the weather event has impacted, or is predicted to impact, a geographic area; receiving building data representative of attributes of a building; receiving exterior element data representative of exterior elements of the building; determining that the geographic area includes a geographic location of the building based upon the geographic area and the building data; obtaining a risk score indicating a baseline probability of damage to the exterior elements of the building; calculating an event-based risk score indicating a probability of damage to the exterior elements of the building due to the weather event based upon the risk score, the building data, the exterior element data, and the weather data; and transmitting, via a communications network, the event-based risk score to a computing device. The method may include additional, fewer, or alternate actions, including those discussed elsewhere herein.

In another aspect, a computer system for predicting risk levels to building exteriors due to weather events may be provided. The computer system may comprise one or more processors and one or more memories storing instructions that, when executed by the one or more processors, cause the one or more processors to: receive weather data indicating attributes of a weather event; determine that the weather event has impacted, or is predicted to impact, a geographic area; receive building data representative of attributes of a building; receive exterior element data representative of exterior elements of the building; determine that the geographic area includes a geographic location of the building based upon the geographic area and the building data; obtain a risk score indicating a baseline probability of damage to the exterior elements of the building; calculate an event-based risk score indicating a probability of damage to the exterior elements of the building due to the weather event based upon the risk score, the building data, the exterior element data, and the weather data; and transmit, via a communications network, the event-based risk score to a computing device. The computer system may be configured to have additional, less, or alternate functionality, including that discussed elsewhere herein.

In yet another aspect, a tangible, non-transitory computer readable medium storing instructions for predicting risk levels to building exteriors may be provided. The instructions, when executed by one or more processors of a computer system, cause the computer system to: receive weather data indicating attributes of a weather event; determine that the weather event has impacted, or is predicted to impact, a geographic area; receive building data representative of attributes of a building; receive exterior element data representative of exterior elements of the building; determine that the geographic area includes a geographic location of the building based upon the geographic area and the building data; obtain a risk score indicating a baseline probability of damage to the exterior elements of the building; calculate an event-based risk score indicating a probability of damage to the exterior elements of the building due to the weather event based upon the risk score, the building data, the exterior element data, and the weather data; and transmit, via a communications network, the event-based risk score to a computing device. The instructions may direct additional, less, or alternate functionality, including that discussed elsewhere herein.

### BRIEF DESCRIPTION OF DRAWINGS

Advantages will become more apparent to those skilled in the art from the following description of the embodiments which have been shown and described by way of illustration. As will be realized, the present systems and methods may be capable of other and different embodiments, and their details are capable of modification in various respects. Accordingly, the drawings and description are to be regarded as illustrative in nature and not as restrictive.

The Figures described below depict various aspects of the applications, methods, and systems disclosed herein. It should be understood that each Figure depicts an embodiment of a particular aspect of the disclosed applications, systems and methods, and that each of the Figures is intended to accord with one or more possible embodiments thereof. Furthermore, wherever possible, the following description refers to the reference numerals included in the following Figures, in which features depicted in multiple Figures are designated with consistent reference numerals.

FIGS. 1A-G depict various views of an example building site;

FIGS. 2A and 2B depict example climate zone information for the United States;

FIG. 3 illustrates a block diagram of an example computer system for predicting risk levels to building exteriors;

FIG. 4 illustrates a flow diagram of an example method for predicting baseline risk levels to building exteriors;

FIG. 5 illustrates a flow diagram of an example method for predicting risk levels to building exteriors due to a particular weather event; and

FIG. 6 illustrates a flow diagram of an example method for generating risk score generation models.

The Figures depict embodiments for purposes of illustration only. One skilled in the art will readily recognize from the following discussion that additional, and/or alternative embodiments of the systems and methods illustrated herein may be employed without departing from the principles of the invention described herein.

### DETAILED DESCRIPTION

To improve the accuracy of predictions related to damage to building exteriors, the techniques disclosed herein may be used to analyze data collected from disparate sources to determine building-specific risk scores. Such risk scores may further be used to identify and implement remedial actions to reduce risks to building exteriors, either for baseline risks generally affecting a specific building or for event-based risks associated with particular weather events.

In some implementations, the disclosed techniques may be used to generate a baseline risk score indicating a baseline probability of damage predicted to occur to the exterior elements of a building over predefined time interval. The baseline risk score may be calculated based upon a combination of building data, exterior element data, weather data, and climate region data. Accordingly, the baseline risk score is tailored to the particular building and the geographic location of the building. Further, by collecting data from multiple data sources and analyzing the data collectively, combinations of variables (e.g., a particular type of siding and a type of weather event) that influence the risk score can be identified. For example, in some implementations, machine learning models are trained to predict building exterior damage from a variety of specific causes using building data, exterior element data, weather data, and climate region data. These machine learning models can therefore recognize variable combinations that result in a high risk of damage versus a low risk of damage, significantly improving the quality of risk level predictions for specific buildings.

The baseline risk score can be provided to an external entity such as an owner of the building to notify the owner of the likelihood that the exterior elements may be damaged in a subsequent time interval (e.g., within the next year). Accordingly, the entity can proactively initiate remedial actions. In some cases, the techniques of this disclosure may include determining a remedial action and transmitting an indication of the remedial action to the appropriate entity associated with the building for implementation. For example, the entity may be notified of the risk score and factors that either increased or decreased the baseline risk score. The entity can be advised that replacement of a particular material, removal of trees on one or more sides of the building, or performance of a particular maintenance action, for example, may reduce the baseline risk score. The entity can then proactively take action to reduce the probability that the exterior elements will experience damage. Thus, the disclosed methods improve techniques for predicting damage to a building and enable proactive actions to reduce the probability of damage to the building.

In some implementations, the disclosed techniques may be used to generate an event-based risk score indicating a probability of damage to the exterior elements of a building due to a particular weather event. The weather event may have already impacted the building, or may be predicted to impact a geographic area including the building. The event-based risk score can be calculated based upon building data, exterior element data, and weather data for a particular weather event. Further, a baseline risk score, if already calculated, can also inform the event-based risk score. Similar to the baseline risk score, the event-based risk score is tailored to the particular building and the geographic location of the building. The event-based risk score is also customized based upon the specific attributes of the weather event. Further, similar to the baseline risk score, machine learning models capable of generating an event-based risk score may also be trained using building data, exterior element data, and historical weather event data.

The event-based risk score may be provided to an external entity such as an owner of the building or emergency services, to notify the entity that the building has likely been damaged, or is likely to be damaged due to an incoming storm. Accordingly, the entity may proactively initiate remedial actions. For example, if the weather event is predicted to occur, receiving the risk score allows the entity to prepare for the weather event to reduce the probability of damage. In some cases, the techniques of this disclosure may include determining a remedial action and transmitting an indication of the remedial action to an external entity, thereby instructing the external entity on an action that can reduce the likelihood of damage. As another example, if the weather event is predicted to occur, event-based risk scores may be calculated for a plurality of buildings, and emergency services may be notified that a group of buildings are at particular risk of damage. Emergency services can then initiate proactive actions targeted to reduce the risk of damage to the group of buildings. As a further example, if the weather event has already occurred, the event-based risk score can be used to identify buildings that likely have been damaged or may suffer further damage without remedial actions, allowing for quick dispatch of emergency services before damage has physically been inspected. Accordingly, emergency services can be directly targeted to the most-damaged sites, which may be difficult for physical inspectors to reach. Thus, the disclosed methods improve techniques for predicting damage that has occurred due to a weather event, or that will likely occur to a weather event, and enable proactive actions to reduce the probability of damage or quickly provide aid to the location.

In the insurance context, the techniques of this disclosure also improve the speed and accuracy of underwriting or claim processing. For example, in scenarios involving calculation of a baseline risk score, a server that calculates or receives the baseline risk score may automatically generate a recommended premium for an insurance policy for the building based upon the baseline risk score, and transmit the recommended premium to a policyholder. As another example, in scenarios involving calculation of an event-based risk score, a server that calculates or receives the event-based risk score may automatically process a claim related to the building. If the event-based risk score indicates that a weather event has likely damaged the exterior elements of the building to the level of total loss, then the server may automatically issue a payment for the exterior elements. A policyholder can therefore receive reimbursement for a total loss without an insurance inspector visiting the insurance site and without exchanging multiple communications with an insurance provider.

### Exemplary Building Site and Climate Data

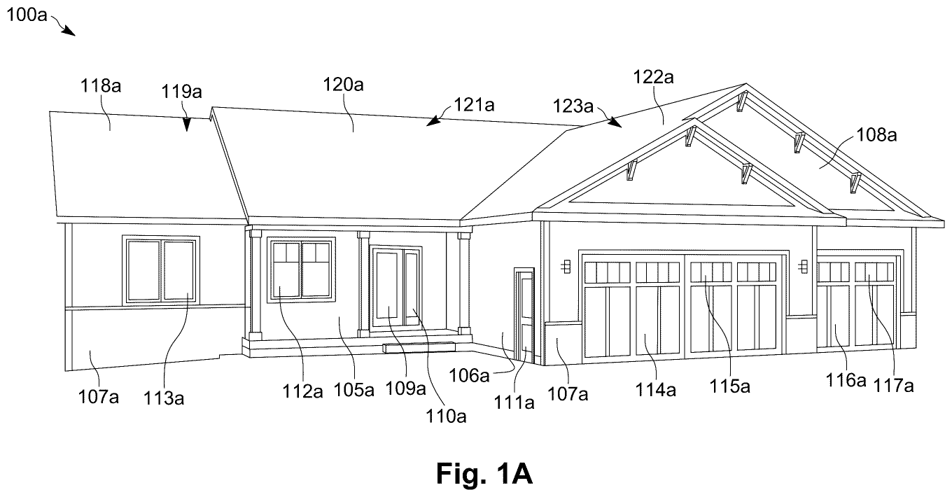

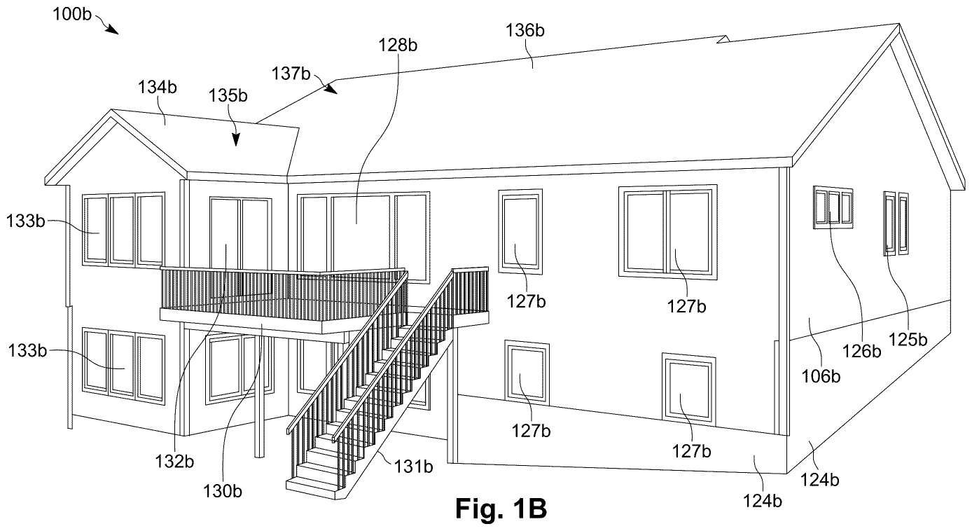

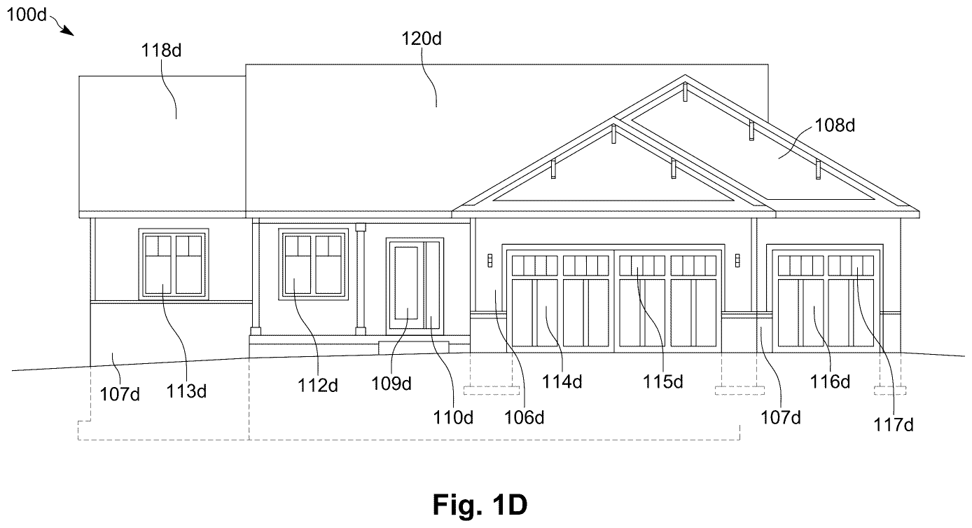

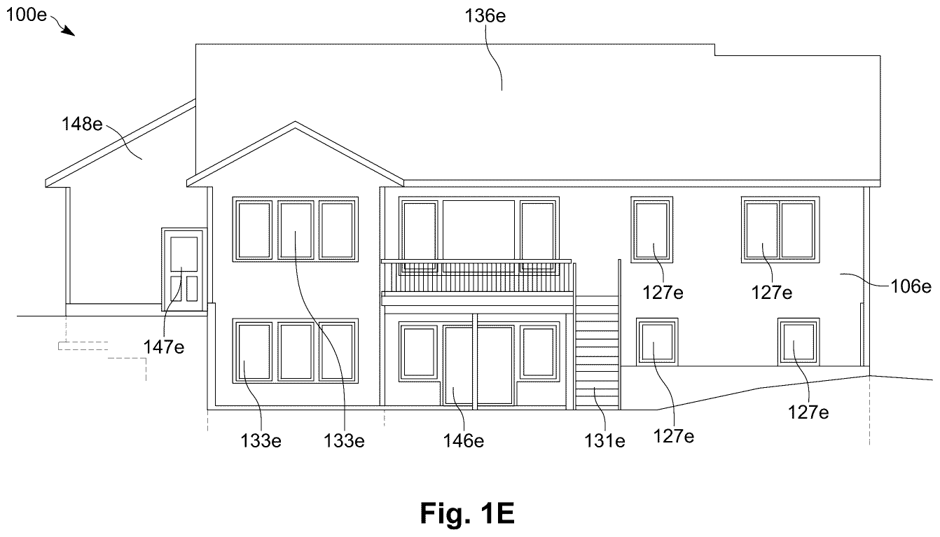

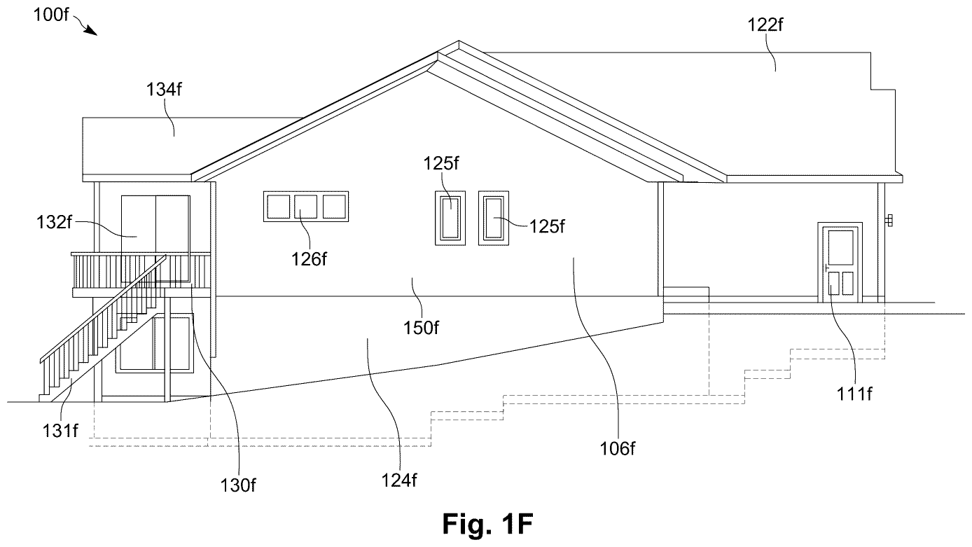

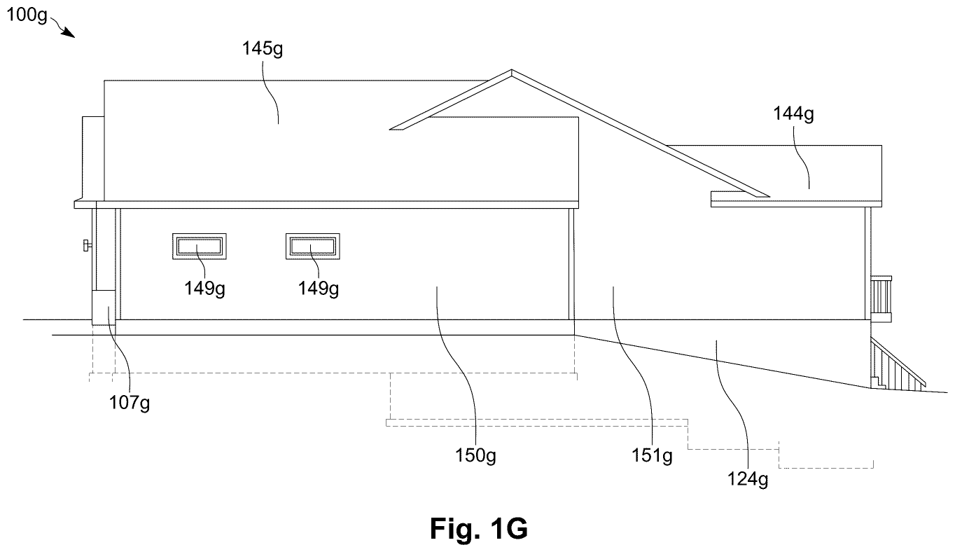

Turning to FIGS. 1A-G, a building site 100a-g may include a building 142c physically located on a building site 140c. The building 142c may be oriented relative to geographic cardinal directions 139c within a building area 141c and may include an access drive 143c. The building 142c may include a plurality of roof sections 118a,c,d, 120a,c,d, 122a,c,f, 134b,c,f, 136b,c,e, 144c,g, 145c,g. As specifically illustrated with respect to FIGS. 1A and 1B, line 119a is tangent to a plane associated with roof section 118a,c,d; line 121a is tangent to a plane associated with roof section 120a,c,d; line 123a is tangent to a plane associated with roof section 122a,c,f; line 135b is tangent to a plane associated with roof section 134b,c,f; and line 137b is tangent to a plane associated with roof section 136b,c,e. As described herein, hail, wind, rain, etc. may impact any given roof section 118a,c,d, 120a,c,d, 122a,c,f, 134b,c,f, 136b,c,e, 144c,g, 145c,g relative to a respective tangent line 119a, 121a, 123a, 135b, 137b differently than any other roof section. Likewise, hail, wind, rain, etc. may impact any given side of the building 142c (i.e., front 105a, first side 150f, second side 151g, rear 148e) different than other sides, and may impact different portions of the sides differently. For example, a higher portion of a particular side may be more impacted by hail than a lower side.

The building 142c may include a front 105a (i.e., the front 105a is oriented generally SSW with respect to geographic cardinal directions 139c) having exterior siding 106a,b,d,e (e.g., vinyl siding, wood siding, laminate siding, aluminum siding, etc.), cultured stone exterior 107a,d,g, shake exterior siding 108a,d, a front entrance door 109a,d, a sidelight 110a,d, a garage walk-in door 111a,f, a front porch window 112a,d, a picture window 113a,d, a two-car garage door 114a,d with windows 115a,d, and a one-car garage door 116a,d with windows 117a,d. As depicted in FIGS. 1A-1G, different portions of the building sides may have different types of siding. For example, the front 105a includes the exterior siding 106a (e.g., vinyl siding) at higher portions of the front 105a, cultured stone exterior 107a at lower portions of the front 105a, and shake exterior siding 108a on a gable of the front 105a.

The building 142c may include a rear 148e (i.e., the rear 148e is oriented generally NNE with respect to geographic cardinal directions 139c) having a rear walk-in garage door 147e, rear windows 127b,e, 133b,e, sliding rear doors 128b, 132b,f, 146e, and a rear deck 130b,f with steps 131b,f.

The building 142c may include a first side 150f (i.e., the first end 150f is oriented generally WNW with respect to geographic cardinal directions 139c) having exterior windows 125f, 126f and basement exterior wall 124f. The building 142c may include a second side 151g (i.e., the second end 151g is oriented generally ESE with respect to geographic cardinal directions 139c) having exterior windows 149g and basement exterior wall 124f.

The building 142c may include other exterior elements not shown in FIGS. 1A-1G. Other exterior elements may include, for example, gutters, downspouts, trim, and exterior lighting. As referred to in this disclosure, the term “exterior elements” of a building refer to exterior elements of a building excluding the roof (e.g., exterior siding 106a,b,d,e, cultured stone exterior 107a,d,g, shake exterior siding 108a,d, front entrance door 109a,d, sidelight 110a,d, garage walk-in door 111a,f, front porch window 112a,d, picture window 113a,d, garage doors 114a,d and 116a,d, garage door windows 115a,d, 117a,d, rear walk-in garage door 147e, rear windows 127b,e, 133b,e, sliding rear doors 128b, 132b,f, 146e, rear deck 130b,f, steps 131b,f, exterior windows 149g, basement exterior wall 124f, gutters (not shown), downspouts (not shown)).

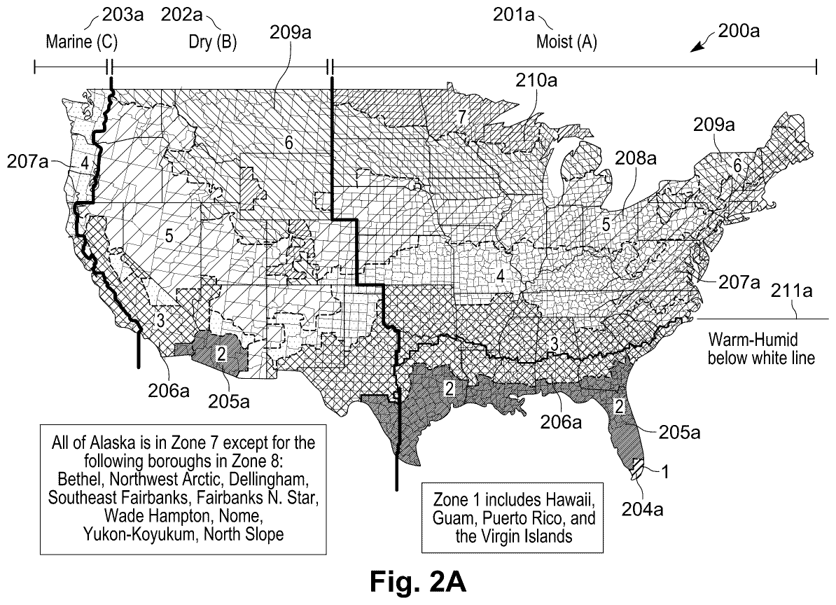

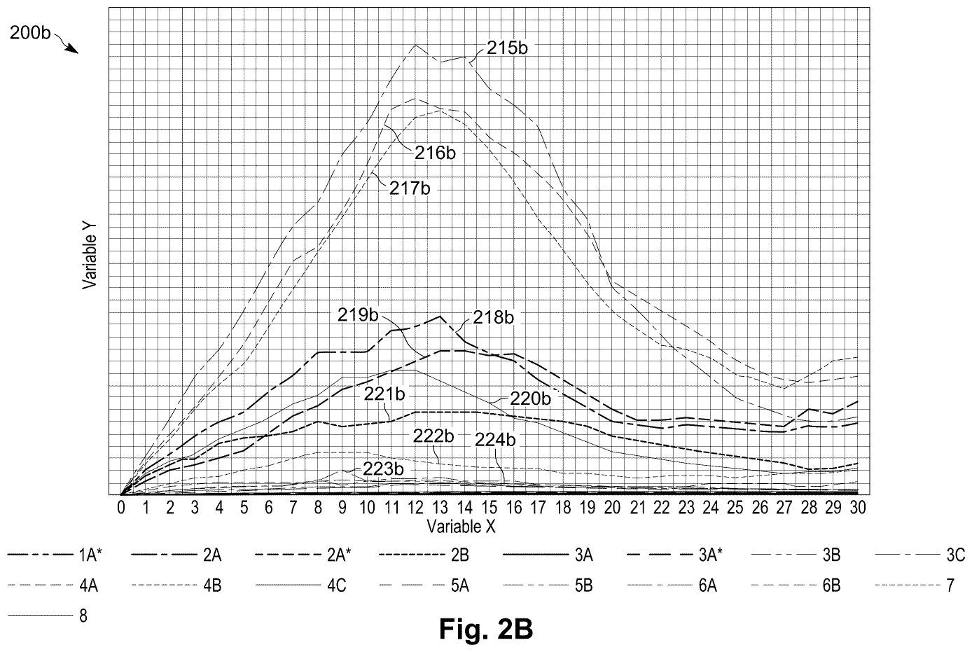

With reference to FIGS. 2A and 2B, climate zone information for the United States 200a may include three generally latitudinally-extending columns 201a-203a (i.e., “moist (A)”, “dry (B)”, and “Marine (C)”), with each column 201a-203c divided into seven generally longitudinally-extending rows 204a-210a (i.e., “Zones 1-7”). Each climate zone (also referred to in this disclosure as a climate region) may then be referenced as, for example, “5A” or “4C” (i.e., climate zone graph lines 215b-224b).

As illustrated in FIG. 2B, a graph 200b may illustrate how exterior building material performance (e.g., roofing material, siding material, windows, gutters, down spouts, etc.) may vary with respect to a climate zone within which an associated building 142c is physically located. For example, a building located in climate zone 215b (i.e., climate zone 5A) may be more likely to experience building exterior damage (e.g., roof damage, siding damage, exterior widow damage, gutter damage, down spout damage, etc.) compared to a building located in climate zone 217b (i.e., climate zone 4C).

The X-Axis of the graph of FIG. 2B may, for example, be representative of an age of an exterior element (e.g., siding) shown as ranging from 0-30 years. The Y-Axis of the graph of FIG. 2B may, for example, be representative of a claim count (e.g., a count of a number of claims filed with a particular insurance company or a group of insurance companies). The claim count, for example, may range from 0-35,000. Thus, the data illustrated by FIG. 2B may be representative of the level of risk associated with different ages of the exterior element. If an age of an exterior element is not known, an exterior element age may be estimated based upon the age of the building and/or any known insurance claims for the building. For example, if building data indicates that a building was built ten years prior, the exterior element age may be estimated to be ten years. If insurance data indicates that a claim was filed for the exterior element that warranted replacement, the estimated age of the exterior element may be determined based on when the claim was filed.

### Exemplary Computer System for Predicting Risk Levels

Turning to FIG. 3, a computer system 300 can implement the exemplary computer-based methods described herein for predicting risk levels to building exteriors. The high-level architecture may include both hardware and software applications, as well as various data communication channels for communicating data between the various hardware and software components. The computer system 300 may be roughly divided into front-end components 302 and back-end components 304. The front-end components 302 may be associated with users and/or entities which receive risk scores and other output data from the back-end components 304. The back-end components 304 may be associated with entities that collect data from a wide range of data sources to calculate risk scores relevant to buildings. For example, the back-end components 304 may be associated with an insurance provider.

The front-end components 302 may communicate with the back-end components 304 via a network 303. Similarly, the back-end components may communicate with one another via the network 303. The network 303 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMax, Wi-Fi, Bluetooth, and others). While FIG. 3 depicts only one network 303, the front-end components 302 and the back-end components 304 may additionally or alternatively communicate via a plurality of networks, depending on the implementation, and still fall within the scope of the present disclosure. For example, the network 303 may include any one or more of an Ethernet-based network, a private network, a cellular network, a local area network (LAN), and/or a wide area network (WAN), such as the Internet.

The back-end components 304 include a risk score generation server 310 configured to generate risk scores (i.e., risk scores indicating a baseline probability of damage to the exterior elements and/or the roof of a building, event-based risk scores indicating a probability of damage to the exterior elements and/or the roof of a building due to a weather event). The risk generation server 310 can generate the risk scores using data received from the front-end components 302 and/or from one or more data sources included in the back-end components 304, including a building data server 340, a roof data server 342, an exterior element data server 344, a hail data server 346, a weather data server 348, and a climate region data server 350. Each of the data servers 340-350 may be associated with different respective entities, such as different data vendors.

The risk score generation server 310 may include a controller 312, which may include a program memory 314, a random-access memory (RAM) 316, one or more processors 318, and an input/output (I/O) circuit 320, all of which may be interconnected via an address/data bus. Although depicted as a single block, the risk score generation server 310 may include one or more servers and/or computing devices. It should also be appreciated that although FIG. 3 depicts only one processor 318, the controller 312 may include multiple processors 318. The one or more processors 318, for example, may include one or more general purpose (e.g., CPUs or microprocessors) and/or special purpose processors. Similarly, the memory of the controller 312 may include multiple RAMs 316 and multiple program memories 314. The controller 312 may implement the RAMs 316 and the program memories 314 as semiconductor memories, magnetically readable memories, or optically readable memories, for example. The one or more processors 318 may be adapted and configured to execute any of the modules, applications, application programming interfaces (APIs), or software routines residing in the program memory 314. The I/O circuit 320 may include one or more I/O circuits, which may be different types of I/O circuits. For example, the I/O circuit 320 may include one or more transceiver circuits to facilitate communication over the network 303. Further, the risk score generation server 310 may include other components not illustrated in FIG. 3, such as a display that may present a graphical user interface (GUI) allowing a user to interact with the modules of the risk score generation server 310, and an input unit allowing the user to provide information to the modules.

The risk score generation server 310 may further include a database 328, which may be adapted to store data related to risk score requests associated with a plurality of users and/or user profiles and preferences. For example, the risk score generation server 310 may be associated with an insurance provider. Users having insurance policies and/or user profiles with the insurance provider may request risk scores for a particular building. In some embodiments, the database 328 may store data from the data servers 340-350 (e.g., information related to using APIs of the other data servers and/or the risk score generation server 310 to communicate with the other servers).

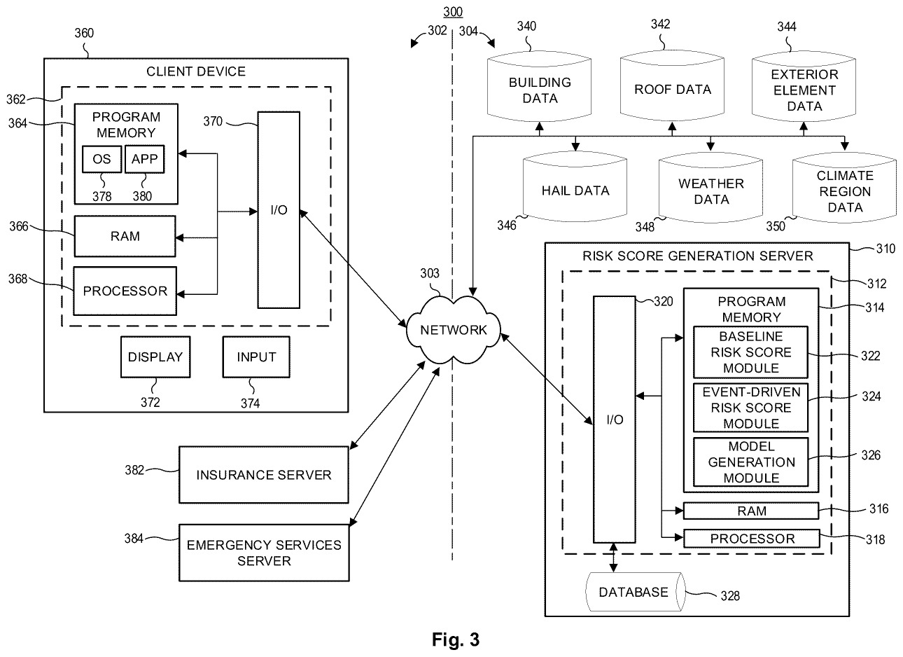

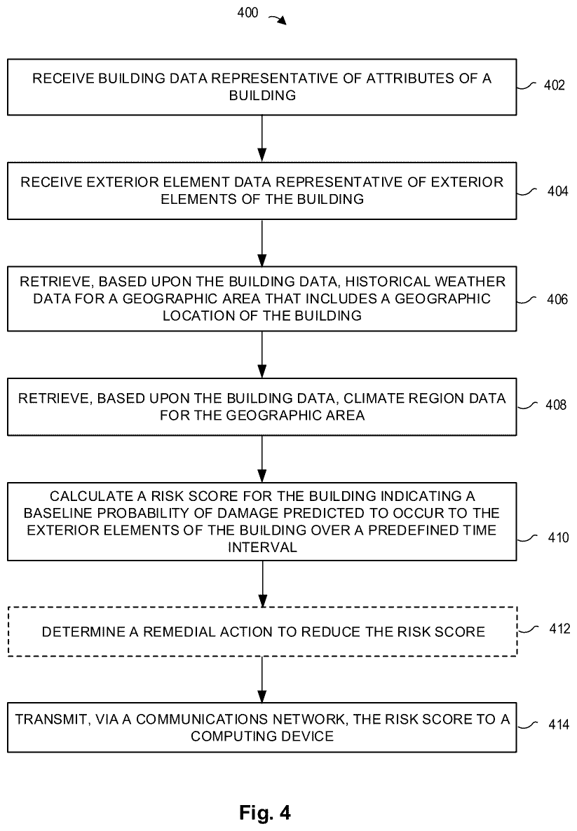

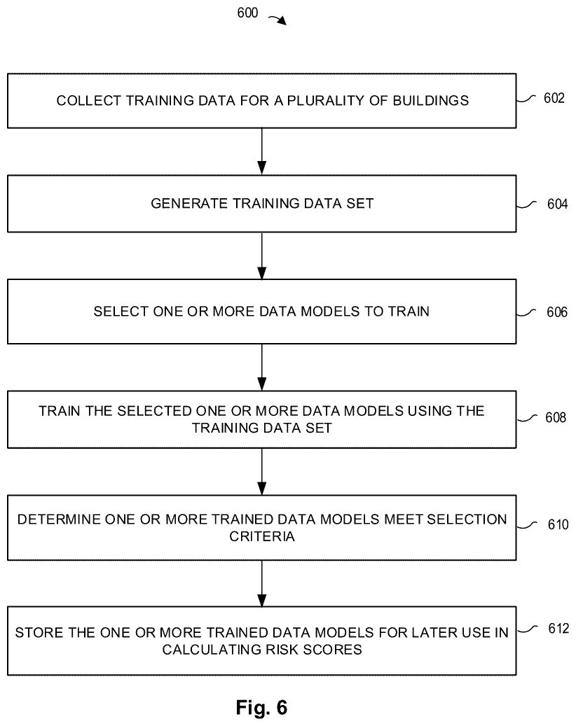

The program memory 314 may include a baseline risk score module 322, an event-driven risk score module 324 and a model generation module 326. The modules 322, 324, and 326 are configured to implement exemplary methods 400, 500, and 600, respectively, as discussed below with reference to FIGS. 4-6. More particularly, the baseline risk score module 322 is configured to generate baseline risk scores indicating a baseline probability of damage to exterior elements of a building and/or to a roof of the building (i.e., over a predefined time interval). The event-driven risk score module 324 is configured to generate event-based risk scores indicating a probability of damage to exterior elements of a building and/or to a roof of the building due to a weather event that has impacted, is currently impacting, or is predicted to impact, the building. The baseline risk score module 322 and the event-driven risk score module 324 may calculate risk scores (i.e., baseline risk scores and/or event-based risk scores) using risk score generation models generated by the model generation module 326. The risk score generation models may calculate risk scores using rules generated by statistical analysis of input data (i.e., in a rules-based approach), probability functions weighted based upon statistical analysis of input data, and/or machine learning models trained using input data (e.g., using a training method as described with reference to FIG. 6). The input data used to generate the risk score generation models includes data from the one or more of data servers 340-350.

Each of the data servers 340-350 may store and/or generate data that the risk score generation server 310 utilizes to generate risk score generation models and to calculate risk scores. Like the risk score generation server 310, each of the data servers 340-350 may include one or more servers, databases, and/or computing devices, despite being depicted as single blocks. Furthermore, the functions of each server (i.e., the risk generation server 310 or any of the data servers 340-350), such as data storage and processing, may be distributed among a plurality of servers in an arrangement known as “cloud computing.” This configuration may provide various advantages such as enabling real-time uploads and downloads of information, as well as providing additional computing resources needed to handle the tasks described herein. This may in turn support a thin-client embodiment of some of the front-end components 302, such as the client device 360.

The building data server 340 stores building data representative of attributes of a plurality of buildings. One such example building may be the building 142c illustrated in FIGS. 1A-G. Attributes of a building may include one or more of: a geographic location of the building (e.g., latitude and longitude), a building orientation relative to geographic cardinal directions, a number of stories of the building (e.g., whether the building is single-story, two-story, or multi-story), building type or construction type (e.g., wood frame, steel frame, or brick), whether there is tree cover over the building and if so, an amount (e.g., a percentage of the total roof area) of tree cover, location and height of structures (e.g., other buildings or natural structures, including trees) surrounding the building (e.g., within a predetermined area from the building), landscaping surrounding the building, elevation of terrain surrounding the building, or whether the building is in a rural area or an urban area.

The roof data server 342 stores roof data representative of a plurality of roofing systems covering a respective plurality of buildings. The roof data for a particular roof may be representative of a structural truss system that forms the design and shape of the roof. Further, the roof data for a particular roof for a building may be representative of one or more of: the roof sheathing, underlayment, roofing felt, membrane, self-adhered water and ice-dam protection membrane, tar, tar paper, exterior roofing material covering, roof vents, flashing and drip edges, and any other component comprising part of the overall roof surface covering of the building. The roof data may be representative of at least one of: a roofing product age, roof area, a roofing material type, a roofing design, a roofing configuration, a roofing product condition, whether a roof is a gable roof, whether a roof is a hip roof, a roof slope, a number of layers of roofing material, a roof deck condition, a roofing manufacturer product testing result, a roofing installation criteria, a roofing product impact testing result, a roofing product wind testing result, a roofing installation, whether a roofing product complies with a particular roof impact test standard or protocol, whether the roofing product is impact resistant rated, a roofing product impact resistance rating, a roofing product wind rating, a roofing shingle specification, whether a roofing product was installed during cold conditions with hand-sealed roofing cement, a roof underlayment, a roofing facer technology, a polyisocyanurate roofing insulation, an EPS insulation, whether a roof includes roof ventilation, an attic detail, a roofing product manufacture warranty, a roofing product installer warranty, a roofing product third-party warranty, or whether a manufacturer defect is present for a roofing material (e.g., whether asphalt shingle seal strips properly activate, whether the roofing material experiences excessive granular loss at an early stage in the product life cycle).

The exterior element data server 344 stores exterior element data representative of exterior elements for a plurality of buildings. The exterior element data for a particular building may be representative of one or more of: gutters, downspouts, siding, doors, windows, or decks of the building. For example, the exterior element data can indicate a number of gutters, locations of the gutters on the building, gutter material type, gutter age, gutter condition, a number of downspouts, locations of the downspouts, downspout material type, downspout age, downspout condition, siding material types, a side of the building where siding is located, an elevation of the building where siding is located (e.g., a height on the building where the siding is located), siding age, siding condition, a number of doors, a location of a door, a material type of a door, whether a door has windows, door age, door condition, a number of windows, a location of a window, a window type, window age, window condition, a location of a deck on the building, a size of the deck, decking material, deck age, deck condition, external stair location, external stair material type, external stair handrails, external stair age, external stair condition, building trim locations, building trim material types, building trim age, building trim condition, or any other attribute of an exterior element of the building.

As an example, the building data server 340, roof data server 342, and exterior element server 344 may include attributes of the building 142C, the roof of the building 142C, and the exterior elements of the building 142C, described above with reference to FIGS. 1A-1G.

The hail data server 346 may store data representative of attributes of historical hail that has impacted geographic areas including the plurality of buildings. Attributes of hail may include one or more of: a physical characteristic of the hail, a size of the hail, a shape of the hail, a density of the hail, a hardness of the hail, a range of hail sizes produced by a storm, or a resistance to flexing of the hail.

The weather data server 348 may store weather data representative of storm attributes associated with historical storms that have occurred in geographic areas including the plurality of buildings. The attributes of a storm may include one or more of: a storm meteorological signature, a storm duration, a storm direction, temperatures during the storm, whether a storm is conducive to producing damaging hail, whether a storm is conducive to producing strong winds, key meteorological aspects of a storm, precipitation amounts and types due to the storm, wind speeds and wind directions due to the storm (e.g., wind gusts and sustained wind speeds), locations of the storm (e.g., latitude and longitude), etc. The weather data server 348 may include the hail data stored by the hail data server 346. In other words, the hail data may be included in the weather data.

The climate region data server 350 may store data representative of climate regions including the plurality of buildings (e.g., data representative of the climate regions depicted in FIG. 2A, such as the data illustrated by FIG. 2B). The climate region data for a geographic area may be representative of: a climate, a humidity, a temperature (e.g., an average temperature for a particular time of year or for the year), a range of temperatures (e.g., a range of temperatures from an average or absolute minimum temperature to an average or absolute maximum temperature), a moisture level (e.g., a climate moisture index), a humidity, wind speeds for the geographic area (e.g., a range of wind speeds, an average wind speed), or an indication of whether the geographic area is associated with a marine climate.

The data collected and stored at the one or more of the data servers 340-350 may be generated by a variety of data sources. Possible data sources for different types of data are listed in Table 1, below. As indicated by Table 1, a portion of the data stored at one or more of the data servers 340-350 be extracted from insurance claim data.

TABLE 1

| Item | Variable | Data Source |
|---|---|---|
| A | Risk Location (Latitude, | Policy Master Record |
| | Longitude) | |
| B | Storm Signature (Meteorological) | Weather Vendor |
| C | Storm Duration | Weather Vendor |
| D | Wind Speed | Weather Vendor |
| E | Storm Direction | Weather Vendor |
| F | Thermal Shock | Weather Vendor |
| G | Hail Size | Weather Vendor |
| H | Hail Shape | Claim Record, Homeowner, Crowd Sourcing |
| I | Hail Density | Weather Vendor |
| J | Hail Hardness | Weather Vendor |
| K | Roofing Product Age | Policy Master Record, Year Built Basis, Claim |
| | | Reason Codes (Total Roof Loss), Real Property |
| | | Vendor or other vendor |
| L | Roof Area (Exposure) | Policy Master Record, Real Property Vendor, or |
| | | other vendor |
| M | Roofing Material Type | Policy Master Record, Claim Record, Real |
| | | Property Vendor or other vendor |
| N | Roof Design (Configuration) | Real Property Vendor or other vendor, Claim |
| | | Record |
| O | Roof Slope | Real Property Vendor or other vendor |
| P | Roofing Material - No. of Layers | Real Property Vendor, vendor inspection or other |
| | | vendor inspection, Claim Inspection |
| Q | Roof Deck Condition | Real Property Vendor, vendor inspection, Claim |
| | | Inspection |
| R | Roofing Material - Impact Rating | Policy Master Record (IRR Credit) |
| | (Yes/No) | |
| S | Roofing Material - Wind Rating | Manufacturer Reference Material |
| | (Class/MPH) | |
| T | Roofing Material - Proper | Real Property Vendor, vendor inspection, Claim |
| | Installation (Yes/No) | Inspection |
| U | Roofing Material - Manufacturer | Real Property Vendor or other vendor, Claim |
| | Defect Present (Yes/No) | Inspection |
| V | Climate Region | Pacific Northwest National Laboratory - U.S. |
| | | Department of Energy's Building America |
| | | Program |
| W | Physical Structure (Single Story, | Policy Master Record |
| | Two Story, Bi-Level) | |
| X | On-Sight (Tree Cover Present) | Real Property Vendor, vendor inspection or other |
| | | vendor inspection, Claim Inspection |
| Y | Exterior Element Age | Policy Master Record, Year Built Basis, Claim |
| | | Reason Codes (Total Loss Event) |
| Z | Siding Area/Exterior Element | Real Property Vendor or other vendor, vendor |
| | size | inspection |
| AA | Exterior Element Material Type | Real Property Vendor or other vendor, vendor |
| | | inspection, |
| BB | Number/Type of Exterior | Real Property Vendor or other vendor, vendor |
| | Elements | inspection |
| CC | Exterior Element Condition | Real Property Vendor or other vendor, vendor |
| | | inspection |
| DD | Exterior Element Locations | Real Property Vendor or other vendor, vendor |
| | | inspection |

Further, one or more of the data servers 340-350 may be in communication with data collection devices, such as sensors and cameras that gather the various types of data. For example, one or more of the data servers 340-350 may receive data from internet of things (IoT) devices, “smart home” devices such as video doorbells, “smart infrastructure” devices, and/or security cameras. One or more of the data servers 340-350 can extract attributes of a building, exterior elements of a building, weather, hail, and/or climate region from the received data, which may include video, photograph, and/or audio data. For example, the hail data server 346 may estimate at least one characteristic from video, camera, or audio data collected during a weather event including hail, such as a direction of hail, size of hail, density/hardness, elevations of a building exposed to hail, duration of hail at a building location, etc.

The front-end components 302 include a client device 360, which may be associated with a particular building and/or a user that is associated with a particular building. The client device 360 may be any electronic device capable of communicating via the network 303 and presenting information to a user. For example, the client device 360 may be a personal computer, a portable or mobile device such as a tablet computer or smartphone, a wearable computing device such as a smart watch, etc. As another example, the client device 360 may be a smart home device, such as Google Home®, Amazon Alexa®, or other similar devices. The client device 360 may include a controller 362, a display 372, and an input unit 374. Although FIG. 1 depicts a single client device 360, the front-end components may include multiple client devices associated with the same user or different users.

Similar to the controller 312, the controller 362 may include a program memory 364, a RAM 366, one or more processors 368, and an I/O circuit 370, all of which may be interconnected via an address/data bus. The program memory 364 may be similar to the program memory 314, and may include an operating system 378 and an application 380. The operating system 378, for example, may include one of a plurality of general purpose or mobile platforms, such as the Android™, iOS®, or Windows® systems, developed by Google Inc., Apple Inc., and Microsoft Corporation, respectively. The application 380 may be configured to present notifications and information to a user regarding a building, such as a risk score for the building, receive information from the user regarding a building, and exchange information with the back-end components 304. For example, the application 380 may be associated with the same entity that operates the risk score generation server 310, such as an insurance provider. A user of the client device 360 can interact with the application 380 to provide data for a building associated with the user (e.g., building data, exterior element data, roof data, weather data, hail data, climate region data), which the application 380 can transmit to the risk score generation server 310, or to the data servers 340-344. The data for the building associated with the user may be generated by devices such as a video doorbell or security camera, which can transmit the data to the client device 360. The application 380 can also transmit a request to the risk score generation server 310 to request a risk score (e.g., a baseline risk score or an event-driven risk score) for a building. A user can customize the request by, for example, requesting a risk score related to a particular exterior element, a risk score related to a probability of damage over a user-specified period of time, a risk score related to a probability of damage due to an incoming storm that is predicted to impact a geographic area including the building, or a risk score due to a storm that has already occurred.

It is noted that although FIG. 3 illustrates the application 380 as a standalone application, the functionality of the application 380 also can be provided in the form of an online service accessible via a web browser executing on the client device 360, or as a plug-in or extension for another software application executing on the client device 360, etc.

The program memory 364 may also store other applications, software routines, and/or data, such as user profiles and preferences, stored building data, exterior element data, and/or roof data for a building associated with the user, application data for the application 380 or other applications, routine data for the software routines, and other data related to the client device 360 operation. The processor(s) 368, program memory 364, RAM 366, and I/O circuit 370 may be generally similar to the processor(s) 318, program memory 314, RAM 316, and I/O circuit 320, respectively.

The display 372 of the client device 360, along with other integrated or communicatively connected output devices (such as a speaker or haptic device, not shown) may present information to the user of the client device 360. The display 372 may include any known or hereafter developed visual or tactile display technology, including LCD, OLED, AMOLED, projection displays, refreshable braille displays, haptic displays, or other types of displays. The input unit 374 may receive information from the user and may include, for example, a physical or virtual keyboard, a microphone, virtual or physical buttons or dials, or other means of receiving information. In some embodiments, the display 372 may include a touch screen or otherwise be configured to receive input from a user, in which case the display 372 and the input unit 374 may be combined. The display 372 may present user interfaces of applications executing on the client device 360, such as the application 380.

The front-end components may include other computing devices associated with different entities. For example, the front-end components may include an insurance server 382 and/or an emergency services server 384. Similar to the client device 360, the insurance server 382 and the emergency services server 384 may request risk scores from the risk score generation server 310, receive notifications from the back-end components 304, and exchange information with the back-end components 304. The insurance server 382 may be associated with an insurance provider. The emergency services server 384 may be associated with a government entity, a disaster relief entity, or emergency response services, such as police, fire, and medical services.

### Exemplary Methods for Predicting Risk Levels

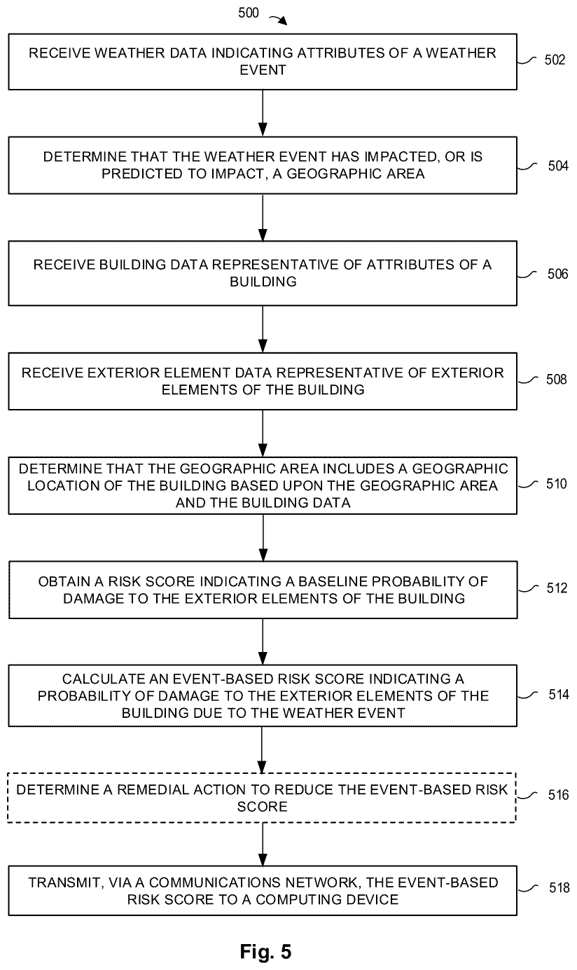

FIGS. 4-5 illustrate example methods for calculating baseline risk scores and event-based risk scores, respectively, and FIG. 6 is an example method for training risk score generation models, which may be used to calculate the risk scores of this disclosure. Various embodiments may include performing any of the exemplary methods 400, 500, and 600 or combinations thereof, as discussed further below.

FIG. 4 illustrates a flow diagram of a method 400 for predicting baseline risk levels to building exteriors. The method 400 may be implemented by the components of the computer system 300. For example, the method 400 may be implemented by the baseline risk score module 322 of the risk score generation server 310. The risk score generation server 310 may perform the method 400 by collecting and processing data from the front-end components 302 (e.g., from the application 380 executing on the client device 360) and from the data servers 340-350. The method 400 may be performed by the processor(s) 318 of the risk score generation server 310 implementing executable instructions stored as computer-readable instructions on the program memory 314.

The computer-implemented method 400 may be performed in response to a trigger event, periodically, or on an ongoing basis to predict a baseline risk level for a building. The baseline risk level, represented by a baseline risk score (also referred to more generally as a risk score, in the discussion of FIG. 4), corresponds to a baseline probability of damage predicted to occur to the exterior elements of the building. A “baseline” probability of damage refers to a probability of damage to a building due to characteristics of the building (e.g., building attributes, exterior element attributes, roof attributes) and the geographic location of the building (e.g., weather and/or climate of the geographic location), rather than due to a specific weather event. The baseline probability of damage may be the probability that the exterior elements of the building will be damaged (e.g., damaged at all, damaged to a particular percentage, or damaged to the point of total loss) within a predetermined time interval. For example, the time interval may a month, a year, or multiple years. Additionally or alternatively, the time interval may correspond to a relevant duration, such as a remaining useful life of an exterior element, a duration a user intends to own or occupy the building, or a duration of an insurance policy. Further, the risk score may be for a particular exterior element (e.g., siding), or for a combination of exterior elements of the building (e.g., siding, gutters, downspouts, doors, and windows).

A trigger event for the method 400 may be a user requesting a risk score using the client device 360. The user may explicitly request a risk score, or may request to initialize or modify an insurance policy for a building. Such request may indicate parameters to be used in generating the risk score, such as a duration, type of damage, or specific exterior elements to cover. A risk score calculated using the method 400 may be used during the underwriting process for the insurance policy. For example, in response to receiving a request for a new insurance policy or a change to an insurance policy, the application 380 (or an application executing on the insurance server 382) may send a request to the risk score generation server 310 for a risk score for the building that will be covered the insurance policy.

In some implementations, the risk score may be a binary value (e.g., indicating whether damage to the exterior elements is likely or not likely to reach a predetermined level within the predetermined time interval, where a first value indicates that the probability is more than 50%, and a second value indicates that the probability is less than or equal to 50%). The predetermined level may be related to a level of damage that would require a particular cost to repair or replace, a level of damage representing a particular amount of damage to the exterior elements, or a level of damage that would be deemed a total loss. In other implementations, the risk score may be a continuous variable (such as a variable ranging from zero to 100, for example) indicating a probability of damage to the exterior elements reaching a predetermined level within the predetermined time interval, or indicating a probability that the exterior elements will be damaged at all. For example, a risk score of 75 may indicate that there is a 75% probability of the exterior elements being damaged (at all, to a particular level, or to the point of total loss) within the predetermined time interval.

The method 400 begins at block 402, where the risk score generation server 310 receives building data representative of attributes of a building. The risk score generation server 310 may receive the building data from the building data server 340, or from a component of the front-end components 302, such as the client device 360. For example, the risk score generation server 310 may receive a request from the client device 360 to calculate a risk score for a building, and the request may include the building data. Alternatively, the request may include an indication, such as an address or an identifier, of a building, and the risk score generation server 310 may retrieve the corresponding building data for the building from the building data server 340. Similarly, at block 404, the risk score generation server 310 receives exterior element data representative of exterior elements of the building. The risk score generation server 310 may receive the exterior element data from the exterior element data server 342, or from a component of the front-end components 302, such as the client device 360. In some implementations, the risk score generation server 310 may retrieve the exterior element data from the exterior element data server 342 based upon the building data.

At block 406, the risk score generation server 310 retrieves, based upon the building data, historical weather data for a geographic area that includes a geographic location of the building. For example, based upon an indication of the geographic location included in the building data that the risk score generation server 310 retrieves at block 402, the risk score generation server 310 can determine the geographic location of the building. Based upon the geographic location, the risk score generation server 310 can retrieve historical weather data for a geographic area that includes the geographic location from the weather data server 348. Retrieving the historical weather data may include retrieving historical hail data for the geographic area from the hail data server 346. Similarly, based upon the building data, the risk score generation server also retrieves, at block 408, climate region data for the geographic area from the climate region data server 350.

At block 410, the risk score generation server 310 calculates a risk score for the building indicating a baseline probability of damage predicted to occur to the exterior elements of the building over a predefined time interval. The risk score generation server 310 may calculate the risk score based upon one or more of: the building data, the exterior element data, the historical weather data, and the climate region data. To calculate the risk score, the risk score generation server 310 may apply a risk score generation model to the building data, the exterior element data, the historical weather data, the climate region data, and/or any combination of these data types. In some implementations, the risk score generation server 310 also receives roof data for the building and applies the risk score generation model to the roof data. In such implementations, the calculated risk score may indicate a baseline probability of damage predicted to occur to both the exterior elements and the roof over a predetermined time interval.

In some implementations, the risk score generation model is an artificial intelligence (AI) model trained using machine learning techniques, discussed with reference to FIG. 6. The AI model may be trained using training data for a plurality of buildings. In other implementations, the risk score generation model includes a probability function. The probability function may include multiple terms having different weights. For example, a first term of the probability function may be weighted, via a first weighting variable, relative to a second term of the probability function. The first term and the second term of the probability function may each be based upon at least one of: the building data, the exterior element data, the historical weather data, or the climate region data. One or more terms of the probability function may be based upon a combination of two or more of the building data, the exterior element data, the historical weather data, and the climate region data. The first weighting variable may be based upon at least one of the building data, the exterior element data, the historical weather data, or the climate region data. As one example, a first term of the probability function may be based upon the exterior element data, and a second term of the probability function may be based upon hail data included in the historical weather data. If the geographic area including the building does not experience hail, the second term may have a weighting variable of zero. In still other implementations, the risk score generation model includes rules determined based upon statistical analysis of training data for a plurality of buildings. For example, a rule may indicate that a given combination of attributes indicated by the building data, exterior element data, weather data, and climate region data indicates a particular probability of damage. In yet other implementations, the risk score generation model is a combination of rules, probability function(s), and AI models.

In some implementations, the method 400 proceeds from block 410 to block 412. In other implementations, the method 400 may omit block 412 and proceed from block 410 to block 414. At block 412, the risk score generation server 310 determines a remedial action to reduce the risk score. The remedial action is a recommended action that the risk score generation server 310 predicts will reduce the risk score. An example remedial action may be a change to a different material type for one or more of the exterior elements, where the different material type is predicted by the risk score generation server 310 to have a lower risk score than the current material type. Another example remedial action may be to replace one or more exterior elements with new exterior elements. A further example remedial action may be to remove trees or landscaping located near the building. A yet further example remedial action may be to perform a particular maintenance action, such as applying an anti-reflective coating to windows. The risk score generation model may generate one or more remedial actions automatically with the risk score, or may generate one or more remedial actions in response to detecting that the risk score is above a given threshold.

At block 414, the risk score generation server 310 transmits, via a communications network (e.g., the network 303), the risk score to a computing device. For example, the risk score generation server 310 may transmit the risk score to one or more of the client device 360, the insurance server 382, or the emergency services server 384. If the risk score generation server 310 generates a remedial action at block 412, the risk score generation server 310 may also transmit an indication of the remedial action to the computing device. If the risk score generation server 310 transmits the risk score to the client device 360, the application 380 may cause the client device 360 to display the risk score. The risk score generation server 310 may determine whether to transmit the risk score and/or the remedial action to the emergency services server 384 depending on whether the risk score is above a given threshold.

Depending on the implementation, the risk score generation server 310 may implement further actions in addition to those depicted in FIG. 4. In some implementations, if the method 400 was initiated in relation to a new insurance policy or a change to an insurance policy for the building, the risk score generation server 310 may automatically initiate an insurance-related action in response to determining the risk score, or in response to determining that the risk score is above a given threshold. For example, the insurance-related action may be to calculate a premium, or decrease or increase an existing premium, based upon the risk score and to transmit the premium to the client device 360 and/or the insurance server 382. Another example insurance-related action may be to transmit a notification, which may include the risk score and/or a remedial action, to an insurance provider that provides coverage for the building. A further example insurance-related action may be to generate at least a portion of insurance policy for the building based upon the risk score and to transmit the at least a portion of the insurance policy to the client device 360 and/or the insurance server 382.

In addition, in some implementations, the risk score generation server 310 may calculate a confidence level of the risk score. The confidence level indicates how confident the risk score generation server 310 is in the accuracy of the risk score. The confidence level may be based, at least in part, on an age (e.g., an average age, or the most recent age) of the building data, the exterior element data, the weather data, and/or the climate region data, where more recent data increases the confidence level and older data decreases the confidence level. The confidence level may also be based upon an amount of building data, exterior element data, weather data, and climate region data that the risk score generation server 310 received. Incomplete fields may reduce the confidence level of the calculated risk score.

FIG. 5 illustrates a flow diagram of a method 500 for predicting risk levels to building exteriors due to a particular weather event. The method 500 may be implemented by the components of the computer system 300. For example, the method 500 may be implemented by the event-driven risk score module 324 of the risk score generation server 310. The risk score generation server 310 may perform the method 500 by collecting and processing data from the front-end components 302 (e.g., from the application 380 executing on the client device 360) and from the data servers 340-350. The method 500 may be performed by the processor(s) 318 of the risk score generation server 310 implementing executable instructions stored as computer-readable instructions on the program memory 314.

The computer-implemented method 500 may be performed to predict an event-based risk level for a building. The event-based risk level, represented by an event-based risk score, corresponds to a probability of damage predicted to occur to the exterior elements of the building due to a weather event. The weather event may be predicted to impact a building or have already impacted the building, which may include ongoing weather events currently impacting the building at the time of risk assessment. For example, the probability of damage may be the probability that the exterior elements of the building will be damaged (e.g., damaged at all, damaged to a particular extent, or damaged to the point of total loss) due to a weather event that is predicted to occur (e.g., forecast to occur, based upon meteorology, within a short period of time, such as a minute, an hour, a day, or a week). As another example, the probability of damage may be a probability that the exterior elements of the building have been damaged (e.g., damaged at all, damaged to a particular extent, or damaged to the point of total loss) by a weather event that has recently occurred. In particular, if the weather event has already occurred, the probability of damage may be a probability that the damage due to the weather event is sufficient to be a total loss. Event-based risk level predictions prior to a weather event may be used to identify remedial actions to prevent or limit damage, while event-based risk level predictions after a weather event may be used to identify likely damage and optimize the repair process (e.g., by prioritizing buildings for inspection, automatically providing data for a claims process, or directing emergency or repair personnel to sites of buildings with high probabilities of damage).

In some implementations, the event-based risk score may be a binary value (e.g., indicating whether damage to the exterior elements is likely or not likely to reach a predetermined level due to the weather event, where a first value indicates that the probability is more than 50% and a second value indicates that the probability is less than or equal to 50%). The predetermined level may be related to a level of damage that would require a particular cost to repair or replace, a level of damage representing a particular amount of damage to the exterior elements, or a level of damage that would be deemed a total loss. In other implementations, the event-based risk score may be a continuous variable (such as a variable ranging from zero to 100, for example) indicating a probability of damage to the exterior elements reaching a predetermined level due to the weather event, or indicating a probability that the exterior elements will be damaged, to any amount, due to the weather event. For example, an event-based risk score of 75 may indicate that there is a 75% probability of the exterior elements being damaged (at all, to a particular level, or to the point of total less) due to the weather event.

The method 500 may be performed in response to a trigger event. A trigger event for the method 500 may be a user requesting an event-based risk score using the client device 360. The user may explicitly request an event-based risk score, and may specify an upcoming weather event or a weather event that has occurred. Additionally or alternatively, a user may file a claim for the building due to damage from a weather event, which may cause the application 380 (or an application executing on the insurance server 382) to send a request to the risk score generation server 310 for an event-based risk score. As another example, a trigger event for the method 500 may be an entity, such as an insurance provider or an emergency services provider, manually or automatically requesting an event-based risk score for a building, or a group of buildings within a geographic area, due to an upcoming weather event or a weather event that has occurred. As a further example, the risk score generation server 310, or another computing device in communication with the risk score generation server 310, may monitor weather data for a region and, in response to detecting that a weather event is going to impact a geographic area, cause the risk score generation server 310 to calculate an event-based risk score for one or more buildings in the geographic area.

The method 500 begins at block 502, where the risk score generation server 310 receives weather data indicating attributes of a weather event. The weather event may include: a storm that produces lightning (i.e., a thunderstorm), rain, hail, freezing rain, snow, and/or high winds (e.g., winds above average conditions for the geographic location at the relevant time of year), extreme heat (i.e., heat above average conditions for the geographic location at the relevant time of year), extreme cold (i.e., cold below average conditions for the geographic location at the relevant time of year), tropical storm, tropical depression, hurricane, typhoon, cyclone, tornado, windstorm, wildfire, flood, or any extreme weather event. Attributes of a weather event such as a storm may include: a storm meteorological signature, a storm duration, a storm direction, whether the storm is conducive to producing damaging hail, and/or whether the storm is conducive to producing strong winds. Attributes of a weather event that produces hail may include: a physical characteristic of the hail, a size of the hail, a shape of the hail, a density of the hail, a hardness of the hail, a range of hail sizes produced by the weather event, and/or a resistance to flexing of the hail. Other example attributes of a weather event may include wind speeds, a type of precipitation produced by the weather event, an amount or rate of precipitation produced by the weather event, a speed of the weather event, a temperature of the weather event, a geographic path of the weather event, and/or a timing of the weather event.

Depending on the implementation, the risk score generation server 310 may retrieve the weather data from the weather data server 348, or may receive the weather data from another computing device. In some implementations, the risk score generation server 310 and/or the weather data server 348 monitors the weather data collected by the weather data server 348, and detects the occurrence of the weather event. In other implementations, the risk score generation server 310 may receive a request from a component of the front-end components 302, such as the client device 360, the insurance server 382, or the emergency services server 384, to calculate at least one risk score due to a particular weather event. The request may include the weather data, or may include an identification of a weather event, which the risk score generation server 310 can use to retrieve weather data for the weather event from the weather data server 348.

At block 504, the risk score generation server 310 determines that the weather event has impacted, or is predicted to impact, a geographic area. The risk score generation server 310 may determine that a weather event has already impacted a geographic area, is currently impacting the geographic area, or is forecast to impact the geographic area. For forecasts of future impacts, a probability of impact or one or more probabilities of levels of impact (e.g., types of precipitation, total precipitation, or wind speed ranges, or

At block 506, the risk score generation server 310 receives building data representative of attributes of a building. In some implementations, the risk score generation server 310 may retrieve building data from the building data server 340. The risk score generation server 310 may retrieve building data for one or more buildings located in the geographic area identified at block 504. For example, the risk score generation server 310 may retrieve all building data available at the building data server 340 for buildings in the geographic area. In other implementations, the risk score generation server 310 receives building data for the building from another computing device (e.g., a component of the front-end components 302, such as the client device 360, the insurance server 382, or the emergency services server 384). For example, as mentioned with reference to block 502, the risk score generation server 310 may receive a request for an event-based risk score for a building due to a particular weather event. The request may include the building data, or may include an indication, such as an address or an identifier, of a building, and the risk score generation server 310 may retrieve the corresponding building data for the building from the building data server 340.

At block 508, the risk score generation server 310 receives exterior element data representative of exterior elements of the building. Similar to block 506, the risk score generation server 310 may receive the exterior element data from the exterior element data server 342, or from a component of the front-end components 302. In some implementations, the risk score generation server 310 may retrieve the exterior element data from the exterior element data server 342 based upon the building data.

At block 510, the risk score generation server 310 determines that the geographic area includes a geographic location of the building based upon the geographic area identified at block 504 and the building data received at block 506 (e.g., based upon a location of the building indicated in the building data).

At block 512, the risk score generation server 310 obtains a risk score indicating a baseline probability of damage to the exterior elements of the building (also referred to in this disclosure as a baseline risk score). In some implementations, the risk score generation server 310 may retrieve historical weather data and climate region data for the geographic area, and calculate a risk score using the building data, historical weather data climate region data, and exterior element data, in accordance with the techniques discussed with reference to FIG. 4. In other implementations, the risk score generation server 310 may have previously calculated a risk score for the building and stored the risk score (e.g., in the database 328). The risk score generation server 310 can then retrieve the stored risk score.

At block 514, the risk score generation server 310 calculates an event-based risk score indicating a probability of damage to the exterior elements of the building due to the weather event. The risk score generation server 310 may calculate the event-based risk score based upon one or more of: the risk score, the building data, the exterior element data, and the weather data. To calculate the event-based risk score, the risk score generation server 310 may apply a risk score generation model to the building data, the exterior element data, the weather data, the risk score, and/or any combination of these data types. Calculating the event-based risk score may be based upon a combination of variables (e.g., on a direction of winds associated with the weather event relative to a building orientation of the building, on a duration of time the weather event impacted, or is predicted to impact, the geographic location of the building). Further, in some implementations, the risk score generation server 310 also receives roof data for the building and applies the risk score generation model to the roof data. In such implementations, the calculated event-based risk score may indicate a probability of damage predicted to occur to both the exterior elements and the roof due to the weather event.

Similar to block 410 above (relating to calculation of the baseline risk score), the risk score generation model used to calculate the event-based risk score may be include an AI model, rules, probability function(s), or a combination of these. In some implementations, the risk score generation model is an AI model trained using machine learning techniques, discussed with reference to FIG. 6. The AI model may be trained using training data for a plurality of buildings and a plurality of historical weather events. In other implementations, the risk score generation model includes a probability function. The probability function may include multiple terms having different weights. For example, a first term of the probability function may be weighted, via a first weighting variable, relative to a second term of the probability function. The first term and the second term of the probability function may each be based upon at least one of: the building data, the exterior element data, or the weather data. One or more terms of the probability function may be based upon a combination of two or more of the building data, the exterior element data, and the weather data. As one example, a first term of the probability function may be based upon the exterior element data, and a second term of the probability function may be based upon hail data included in the weather data. If the weather event does not include hail, the second term may have a weighting variable of zero. In still other implementations, the risk score generation model includes rules determined based upon statistical analysis of training data for a plurality of buildings and a plurality of historical weather events. For example, a rule may indicate that a given combination of attributes indicated by the building data, exterior element data, and weather data indicates a particular probability of damage.

In some implementations, the method 500 proceeds from block 514 to block 516. In other implementations, the method 500 may omit block 516 and proceed from block 514 to block 518. At block 516, the risk score generation server 310 determines a remedial action to reduce the event-based risk score. The remedial action is a recommended action that the risk score generation server 310 predicts will reduce the event-based risk score, which may be specific to one or more exterior elements having elevated event-based risk scores. In some implementations, the risk score generation server 310 determines the remedial action in scenarios in which the weather event is predicted to impact the geographic area but has not yet impacted in the geographic area. Accordingly, the remedial action may be a preemptive action that can be performed prior to the weather event impacting the geographic area. An example remedial action may be to place coverings (e.g., storm shutters) over one or more exterior elements of the building, such as windows or doors. Another example remedial action may be to trim or remove trees or landscaping surrounding the building. A further example remedial action may be to perform a particular maintenance action, such as cleaning downspouts or gutters. The risk score generation model may generate one or more remedial actions automatically with the event-based risk score, or may generate one or more remedial actions in response to detecting that the event-based risk score is above a given threshold.

In other implementations, the risk score generation server 310 may determine, either before or after the weather event impacts a geographic area, a remedial action that can be performed after the weather impact impacts the geographic area, i.e., a post-event remedial action. An example post-event remedial action may include transmitting a notification to emergency services and/or repair personnel to indicate that a particular area or group of buildings has likely experienced damage. Another example post-event remedial action may be to determine likely repairs and/or replacements of exterior elements that may be required based on the estimated damage to a building. The risk score generation server 310 may notify repair personnel of the estimated repairs needed based on the event-based risk score, and/or may automatically identify repair costs, replacement costs, and/or replacement materials. Further, the risk score generation server 310 may automatically initiate an insurance claim for the exterior elements have likely been damaged due to the weather event.

At block 518, the risk score generation server 310 transmits, via a communications network (e.g., the network 303), the event-based risk score to a computing device. For example, the risk score generation server 310 may transmit the event-based risk score to one or more of the client device 360, the insurance server 382, or the emergency service server 384. If the risk score generation server 310 generates a remedial action at block 516, the risk score generation server 310 may also transmit an indication of the remedial action to the computing device. If the risk score generation server 310 transmits the risk score to the client device 360, the application 380 may cause the client device 360 to display the risk score. The risk score generation server 310 may determine to transmit a notification including the risk score and/or the remedial action to the emergency services server 384 depending on whether the risk score is above a given threshold. As another example, the risk score generation server 310 may calculate event-based risk scores for multiple buildings in a geographic region. Based upon the event-based risk scores, the risk score generation server 310 may transmit a notification to the emergency services server 384 (e.g., to indicate that multiple buildings in the region are at a risk of damage due to a weather event).

Depending on the implementation, the risk score generation server 310 may implement further actions in addition to those depicted in FIG. 5. In some implementations, if the method 500 was initiated in relation to an insurance claim filed due to damage from the weather event, the risk score generation server 310 may automatically initiate an insurance-related action in response to determining the event-based risk score, or in response to determining that the event-based risk score is above a given threshold. For example, the insurance-related action may be to automatically initiate a payment in response to determining that one or more exterior elements are predicted to be a total loss.

In addition, in some implementations, the risk score generation server 310 may calculate a confidence level of the event-based risk score. The confidence level indicates how confident the risk score generation server 310 is in the accuracy of the event-based risk score. The confidence level may be based, at least in part, on an age (e.g., an average age, or the most recent age) of the building data, the exterior element data, the weather data, the risk score (i.e., the baseline risk score) where more recent data increases the confidence level and older data decreases the confidence level. The confidence level may also be based upon an amount of building data, exterior element data, and weather data that the risk score generation server 310 received. Incomplete fields may reduce the confidence level of the calculated event-based risk score.

FIG. 6 illustrates a flow diagram of an example model training method 600 for generating risk score generation models for generating risk scores (i.e., baseline risk scores and/or event-based risk scores). As discussed above, the risk score generation models may implement a combination of rules, probability functions, and/or machine learning models trained using training data. In implementations in which the risk score generation models include models or portions of models that are trained, the model generation module 326 of the risk score generation server 310 can implement the model training method 600 to train the risk score generation models. Such trained risk score generation models can be stored in the database 328, where they can be accessed by the baseline risk score module 322 and the event-driven risk score module 324. Further, while the examples discussed in this disclosure primarily refer to the risk score generation models calculating risk scores, the risk score generation models can also be trained to determine remedial actions that are predicted to reduce a given risk score.

The model training method 600 begins by collecting training data for a plurality of buildings from a plurality of external data sources (block 602). The collected training data for the plurality of buildings are combined to generate a training data set (block 604). One or more data models are selected for training on the training data set (block 606) and are trained using the training data set (block 608), until one or more trained data models meet selection criteria (block 610). The one or more successfully trained data models are then stored for further use in calculating risk scores (block 612). Depending on the embodiment, the model training method 600 may be modified to include additional, fewer, or alternative actions. Further details regarding the model training method 600 are discussed below.

At block 602, the risk score generation server 310 may obtain training data for a plurality of buildings (i.e., training buildings). The collected training data may include training data such as training building data, training exterior element data, training roof data, training weather data, training climate region data, and training damage data indicating damage to exterior elements of the plurality of buildings, which may be collected from data sources such as the data servers 340-350. The training data associated with the training buildings may be collected into a set of training data entries associated with training buildings. For example, a particular training data entry for a particular building may include training building data, training exterior element data, training roof data, training weather data, and training climate region data applicable to the particular building. The particular data entry may also include training damage data indicating whether the particular building experienced damage, what portions of the particular building were damaged, the extent or severity of the damage, and whether the damage is due to a particular weather event. There may be multiple training data entries for a single building. For example, a first training data entry may not be associated with any particular weather event, but rather may indicate general wear-and-tear-type damage to a building over a period of time. A second training data entry may be associated with a first weather event that impacted the building, and a third training data entry may be associated with a second weather event that impacted the building.

At block 604, the risk score generation server 310 may then merge the training data from a plurality of training sources to generate one or more training data sets. Depending on the implementation, different types of training data sets may be formed based upon the type of data model that it is to be trained. For example, a first example training data set may include all available training data entries for the training buildings. A second example training data set may include training data relevant to a particular type of weather event (e.g., a hail storm, a hurricane, a tornado) or to a particular climate region. Another example training data set may include training exterior element data and omit training roof data, which can be used to generate a risk score generation model particular to exterior elements. Any suitable combination of the training data can be merged into a training data set based upon the desired application of the resulting trained risk score generation model.

At block 606, the risk score generation server 310 may select one or more untrained data models to train using a training set of the one or more training data sets. The selected data models may include any type of untrained machine learning models for supervised or unsupervised learning. A model may be specified based upon user input specifying relevant parameters to use as predicted variables, such as a baseline probability of damage predicted to occur to the exterior elements of a building over a predefined time interval (i.e., a baseline risk score), a probability of damage predicted to occur to a particular weather event (i.e., an event-based risk score), a probability that a building will experience a total loss event during a predefined time interval or due to a particular weather event, a prediction of which exterior elements will be damaged, and to what extent (e.g., repairable, total loss, repair/replacement cost), over a predefined time interval or due to a particular weather event, and further based upon other variables to use as potential explanatory variables (e.g., characteristics of the building data, exterior element data, roof data, weather data, climate data, damage data, or particular combinations of such characteristics). For example, a model may be specified to predict the likelihood of an exterior element of a building being damaged due to a hail storm having particular attributes based upon the collected training data. Conditions for training the data model may likewise be selected, such as limits on model complexity or limits on model refinement past a certain point. Because outcomes may vary significantly by building attributes or location, such as whether a building is located in a particular climate region, the models may also be selected to specify characteristics of the training data, and multiple models may be trained for different groups of training buildings. In some embodiments, unsupervised machine learning techniques may be used to determine the relevant characteristics of the training data based upon the training data set.

At block 608, the risk score generation server 310 may train the selected one or more untrained data models using the training data set. To train the data models, the risk score generation server 310 may randomly select a first subset of the training data set to use in generating a trained data model. The selected data model may then be trained on the training data entries in the first subset using appropriate machine learning techniques, based upon the type of model selected and any conditions specified for training the model.

The model may be trained using a supervised or unsupervised machine-learning program or algorithm. The machine-learning program or algorithm may employ a neural network, which may be a convolutional neural network, a deep learning neural network, or a combined learning module or program that learns in two or more features or feature datasets in particular areas of interest. The machine-learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine-learning algorithms and/or techniques.

Machine-learning may involve identifying and recognizing patterns in existing data in order to facilitate making predictions for subsequent data. In some embodiments, due to the processing power requirements of training machine learning models, the selected model may be trained using additional computing resources (e.g., cloud computing resources) based upon data provided by risk score generation server 310. Such training may continue until at least one model is validated and meets selection criteria to be used as a predictive model.

At block 610, the risk score generation server 310 may determine that one or more trained data models meet selection criteria to be selected as a risk score generation model (e.g., a baseline risk score generation model to be used by the baseline risk score module 322 or an event-driven risk score generation model to be used by the event-driven risk score module 324) for calculating risk scores for buildings. Thus, each trained data model may be validated using a second subset of the training data set to determine model accuracy and robustness. Such validation may include applying the trained model to the training data entries of the second subset to predict damage probabilities related to a building. The trained model may then be evaluated to determine whether the model performance is sufficient based upon the validation stage predicted values. The sufficiency criteria applied may vary depending upon the size of the training data set available for training, the performance of previous iterations of trained models, or user-specified performance requirements. When the risk score generation server 310 determines the trained model has not achieved sufficient performance, additional training may be performed at block 608, which may include refinement of the trained model or retraining on a different first subset of the training data set, after which the new trained model may again be validated and assessed at block 610. When the risk score generation server 310 determines that the trained model has achieved sufficient performance at block 610, the trained model may be stored for later use.

At block 612, the risk score generation server 310 may store the one or more selected trained data models for later use in calculating risk scores according to the methods and techniques disclosed herein. The trained risk score generation models may be stored as sets of parameter values or weights for analysis or further input data sets, which may also include analysis logic or indications of model validity in some instances. Thus, a plurality of models may be stored for calculating risk scores under different sets of input data conditions. In some embodiments, trained predictive models may be stored in the database 328, the baseline risk score module 322, and/or the event-driven risk score module 324.

### Additional Considerations

Although the preceding text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. For example, a module may comprise dedicated circuitry or logic that is permanently configured (e.g., as a special-purpose processor, such as a field programmable gate array (FPGA) or an application-specific integrated circuit (ASIC) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in dedicated and permanently configured circuitry, or in temporarily configured circuitry (e.g., configured by software) may be driven by cost and time considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple such modules exist contemporaneously, communications may be achieved through signal transmission (e.g., over appropriate circuits and buses) that connect the modules. In certain embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and may operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the one or more processors or processor-implemented modules may be located in a single geographic location (e.g., at a location of a mobile computing device or at a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Such memories may be or may include non-transitory, tangible computer-readable media configured to store computer-readable instructions that may be executed by one or more processors of one or more computer systems.

As used herein any reference to “one embodiment,” “an embodiment,” “one example,” or “an example” means that a particular element, feature, structure, or characteristic described in connection with the embodiment is included in at least one embodiment. The appearances of the phrases “in one embodiment,” “in an embodiment,” “in some embodiments,” “in one example,” “in some examples,” or similar phrases in various places in the specification are not necessarily all referring to the same embodiment, the same example, or the same set of embodiments or examples.

Some embodiments may be described using the terms “coupled,” “connected,” “communicatively connected,” or “communicatively coupled,” along with their derivatives. These terms may refer to a direct physical connection or to an indirect (physical or communicative) connection. For example, some embodiments may be described using the term “coupled” to indicate that two or more elements are in direct physical or electrical contact. The term “coupled,” however, may also mean that two or more elements are not in direct contact with each other, but yet still co-operate or interact with each other. Unless expressly stated or required by the context of their use, the embodiments are not limited to direct connection.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless the context clearly indicates otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for the systems and a methods disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

Finally, the claims at the end of this patent are not intended to be construed under 35 U.S.C. § 112 (f), unless traditional means-plus-function language is expressly recited, such as “means for” or “step for” language being explicitly recited in the claims. The systems and methods described herein are directed to an improvement to computer functionality, which may include improving the functioning of conventional computers in performing tasks.

What is claimed is:

1. A computer-implemented method for providing warnings based upon risk levels to building exteriors, the computer-implemented method comprising:
receiving, at one or more processors, building data representative of attributes of a building;
receiving, at the one or more processors, exterior element data representative of exterior elements of the building;
retrieving, by the one or more processors based upon the building data, sensor data collected from a plurality of smart home devices each comprising a device controller implementing an application to control performance of automated tasks, one or more sensors, and a communication component for electronic communication with a remote server via a communication network and disposed within a geographic area that includes a geographic location of the building, wherein the sensor data comprises video, audio, or image data captured by the plurality of smart home devices during a plurality of storms that have occurred in the geographic area;
generating, by the one or more processors, historical weather data for the geographic area that includes the geographic location of the building from the sensor data, wherein the historical weather data comprises storm attributes associated with the plurality of storms that have occurred in the geographic area;
retrieving, by the one or more processors based upon the building data, climate region data for the geographic area, wherein the climate region data comprises one or more averages or ranges of the following associated with a climate zone of the geographic area: humidity, temperature, moisture level, or wind speed;
calculating, by the one or more processors, a risk score for the building indicating a baseline probability of damage predicted to occur to the exterior elements of the building over a predefined time interval by applying a risk score generation model to the building data, the exterior element data, the historical weather data, and the climate region data; and
in response to determining the risk score exceeds a threshold risk level:
determining, by the one or more processors, a remedial action predicted to reduce the risk score below the threshold risk level; and
causing, by the one or more processors, the remedial action to be performed to reduce an expected need for future repairs to the exterior elements of the building by transmitting an indication of the remedial action to a computing device associated with the building.

2. The computer-implemented method of claim 1, wherein the risk score generation model is trained using training data associated with a plurality of buildings.

3. The computer-implemented method of claim 2, wherein the training data includes training building data, training exterior element data, training weather data, training climate region data, and training damage data indicating damage to exterior elements of the plurality of buildings, the method further comprising:
training, by the one or more processors, the risk score generation model using the training data.

4. The computer-implemented method of claim 1, wherein the risk score generation model includes a probability function.

5. The computer-implemented method of claim 4, wherein a contribution of a first term of the probability function is weighted, via a first weighting variable, relative to a second term of the probability function.

6. The computer-implemented method of claim 5, wherein the first term and the second term of the probability function are each based upon at least one of the building data, the exterior element data, the historical weather data, or the climate region data.

7. The computer implemented method of claim 5, wherein the first weighting variable is based upon at least one of the building data, the exterior element data, the historical weather data, or the climate region data.

8. The computer-implemented method of claim 1, further comprising:
calculating, by the one or more processors, a confidence level of the risk score based at least in part on an age of one or more of the building data, exterior element data, the historical weather data, or the climate region data.

9. The computer-implemented method of claim 1, further comprising:
receiving, at the one or more processors, roof data representative of a structure forming an upper covering of the building;
wherein calculating the risk score is further based upon the roof data.

10. The computer-implemented method of claim 1, wherein the exterior element data is representative of one or more of: gutters of the building, downspouts of the building, siding of the building, doors of the building, or windows of the building.

11. The computer-implemented method of claim 1, wherein the attributes of the building include at least one of: the geographic location of the building, a building orientation relative to geographic cardinal directions, a number of stories of the building, whether there is tree cover over the building, location and height of structures surrounding the building, or elevation of terrain surrounding the building.

12. A computing system for providing warnings based upon risk levels to building exteriors, the computing system comprising:
one or more processors; and
one or more memories storing instructions that, when executed by the one or more processors, cause the one or more processors to:
receive building data representative of attributes of a building;
receive exterior element data representative of exterior elements of the building;
retrieve, based upon the building data, sensor data collected from a plurality of smart home devices each comprising a device controller implementing an application to control performance of automated tasks, one or more sensors, and a communication component for electronic communication with a remote server via a communication network and disposed within a geographic area that includes a geographic location of the building, wherein the sensor data comprises video, audio, or image data captured by the plurality of smart home devices during a plurality of storms that have occurred in the geographic area;
generate historical weather data for the geographic area that includes the geographic location of the building from the sensor data, wherein the historical weather data comprises storm attributes associated with the plurality of storms that have occurred in the geographic area;
retrieve, based upon the building data, climate region data for the geographic area, wherein the climate region data comprises one or more averages or ranges of the following associated with a climate zone of the geographic area: humidity, temperature, moisture level, or wind speed;
calculate a risk score for the building indicating a baseline probability of damage predicted to occur to the exterior elements of the building over a predefined time interval by applying a risk score generation model to the building data, the exterior element data, the historical weather data, and the climate region data; and
in response to determining the risk score exceeds a threshold risk level:
determine a remedial action predicted to reduce the risk score below the threshold risk level; and
causing, by the one or more processors, the remedial action to be performed to reduce an expected need for future repairs to the exterior elements of the building by transmitting an indication of the remedial action to a computing device associated with the building.

13. The computing system of claim 12, wherein the risk score generation model is trained using training data associated with a plurality of buildings.

14. The computing system of claim 13, wherein the training data includes training building data, training exterior element data, training weather data, training climate region data, and training damage data indicating damage to exterior elements of the plurality of buildings, and wherein the instructions further cause the one or more processors to:
train the risk score generation model using the training data.

15. The computing system of claim 12, wherein the risk score generation model includes a probability function.

16. The computing system of claim 12, wherein the instructions further cause the one or more processors to:
calculate a confidence level of the risk score based at least in part on an age of one or more of the building data, exterior element data, the historical weather data, or the climate region data.

17. The computing system of claim 12, wherein the exterior element data is representative of one or more of: gutters of the building, downspouts of the building, siding of the building, doors of the building, or windows of the building.

18. A tangible, non-transitory computer-readable medium storing executable instructions for providing warnings based upon risk levels to building exteriors that, when executed by one or more processors of a computer system, cause the computer system to:
receive building data representative of attributes of a building;
receive exterior element data representative of exterior elements of the building;
retrieve, based upon the building data, sensor data collected from a plurality of smart home devices each comprising a device controller implementing an application to control performance of automated tasks, one or more sensors, and a communication component for electronic communication with a remote server via a communication network and disposed within a geographic area that includes a geographic location of the building, wherein the sensor data comprises video, audio, or image data captured by the plurality of smart home devices during a plurality of storms that have occurred in the geographic area;
generate historical weather data for the geographic area that includes the geographic location of the building from the sensor data, wherein the historical weather data comprises storm attributes associated with the plurality of storms that have occurred in the geographic area;
retrieve, based upon the building data, climate region data for the geographic area, wherein the climate region data comprises one or more averages or ranges of the following associated with a climate zone of the geographic area: humidity, temperature, moisture level, or wind speed;
calculate a risk score for the building indicating a baseline probability of damage predicted to occur to the exterior elements of the building over a predefined time interval by applying a risk score generation model to the building data, the exterior element data, the historical weather data, and the climate region data; and
in response to determining the risk score exceeds a threshold risk level:
determine a remedial action predicted to reduce the risk score below the threshold risk level; and
causing, by the one or more processors, the remedial action to be performed to reduce an expected need for future repairs to the exterior elements of the building by transmitting an indication of the remedial action to a computing device associated with the building.

19. The tangible, non-transitory computer-readable medium of claim 18, wherein the risk score generation model is trained using training data associated with a plurality of buildings.

20. The tangible, non-transitory computer-readable medium of claim 18, wherein the instructions further cause the computer system to:
calculate a confidence level of the risk score based at least in part on an age of one or more of the building data, exterior element data, the historical weather data, or the climate region data.
